(19) United States
(12) Patent Application Publication
(10) Pub. No.: US 2017/0270606 A1
(43) Pub. Date: Sep. 21, 2017

(54) System and Method for Selecting Portfolio Managers and Products

(71) Applicant: Tina S Byles Williams, Phildelphia, PA (US)

(72) Inventor: Tina S Byles Williams, Phildelphia, PA (US)

(73) Assignee: Fiduciary Investment Solutions, Inc., Philadelphia, PA (US)

(21) Appl. No.: 15/071,603

(22) Filed: Mar. 16, 2016

(51) Int. Cl. G06Q 40/04; G06Q 40/06

(52) U.S. Cl. CPC G06Q 40/04; G06Q 40/06

(57) ABSTRACT

Disclosed are a system and a method for selecting index Portfolio Managers/Products and active Portfolio Managers/Products for an investment portfolio. The invention described herein separates the performance impact of temporal market events from a Portfolio Manager's active security and/or factor selection skill. Furthermore, the invention described herein uses forecasting methods to improve the accuracy with which investors can select Portfolio Managers/Products that are likely to outperform their peers. In one embodiment, the method prepares data by calculating excess returns for each Portfolio Manager/Product within a universe of Portfolio Managers/Products using stock market indices and extracting Active Share from various datasets. Additionally, the method extracts raw factor data and generates composite indices for sectors. Several analytical inputs are then generated using edge measure and skill score measure. Each Portfolio Manager's/Product's rolling excess return is quartiled or segmented and a logistic regression model is calibrated to forecast performance.

### FIELD OF THE INVENTION

The present invention generally relates to investment portfolios. More particularly, the present invention is directed to a system and method for selecting investment managers and products for both separately managed and pooled investment accounts (hereinafter referred to collectively as “Portfolio Managers/Products”) that are likely to outperform among a universe of managers using real-world data.

### BACKGROUND OF THE INVENTION

Investors hire portfolio managers to act as their agents, and portfolio managers are trusted to perform to the best of their abilities and in the investors' best interests. Portfolio manager selection is a critical step in implementing any investment program. In most cases, investors choose portfolio managers to determine the most appropriate product(s) in which to place assets. Investors want portfolio managers who are highly skilled, diligent, and persistent; and they also want portfolio managers whose interests are aligned with their own. Investors must practice due diligence when selecting index Portfolio Managers/Products or active Portfolio Managers/Products.

Selecting Portfolio Managers is a complicated and difficult process, however. Portfolio Manager/Product performance varies over time, and such performance is driven by factors that are both controllable by and outside the control of Portfolio Managers. Thus, a Portfolio Manager's skill in actively selecting securities is often conflated with the performance impact of temporal market and other factors that passively favor or disfavor the Portfolio Manager's particular investment approach. In other words, active security or factor selection skill is often conflated with luck. The invention described herein addresses these problems by separating the performance impact of temporal market events (i.e., luck) from a Portfolio Manager's active security and/or factor selection skill.

One of the methods by which investors select Portfolio Managers/Products is to compare them to their Portfolio Manager/Product peers that belong to substantially similar style segments of the Portfolio Manager/Product universe. For such evaluations, common units of comparison include historical returns over various trailing periods, risk-adjusted return measures (such as the Sharpe Ratio and/or Information Ratio) over various trailing periods, and/or Morningstar ratings for registered funds. Additionally, after a Portfolio Manager/Product has been retained, investors commonly evaluate performance on the basis of the above referenced comparisons. However, several studies have demonstrated that these selection criteria have limited accuracy in predicting future peer relative out-performance and are subject to substantial performance degradation over the three to five-year contractual term for which investment managers are typically retained. The invention described herein addresses these problems by using forecasting methods to improve the accuracy with which investors can select Portfolio Managers/Products that are likely to outperform their peers.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

The present invention provides a system and method for forecasting Portfolio Managers/Products that are most likely to outperform relative to their peers within discreet public equity style categories. The first step of the method is preparing data. In one embodiment, the method begins with using subsets of listed funds from the Petajisto (2013) dataset that are benchmarked against the Russell 1000 Index as well as registered mutual funds classified by Morningstar, Inc. (hereinafter referred to as “Morningstar”) in the broad equity universe. It is noted that various types of commercial database or proprietary input data may be used regarding Portfolio Manager/Products. In order to test the methodology for Small Capitalization U.S. and Non-U.S. equity stock funds, the present method uses subsets of the mutual funds that benchmark themselves to the Russell 2000, S&P 600 and MSCI EAFE index, respectively. The methodology also evaluates the performance of stocks of different factor and industry groups for various categories of investment management styles within the broad public equity stock universe.

The present method extracts market index and fund returns, as well as Active Share data for each fund or product from the Petajisto and Morningstar fund universe datasets and calculates various performance measures including excess return and a modified measure or return consistency or batting average. The method also extracts raw factor data for factors and industries from Barra; and generates composite indices for sectors using Barra. The method is configured to identify factor exposures and disaggregate the effects of factors from stock selection given a measure of a manager's excess return in order to determine managers' skills and choose one or more managers for given portfolios. The managers' excess returns are then segmented into overall excess return, factor “clone” excess return, and stock selection excess return.

The first step of the method can also be implemented using other factor exposure databases such as FactSet, Axioma or Bloomberg, as well as other Portfolio Manager databases such as Evestment, FactSet or an end user's proprietary Portfolio Manager database.

The second step of the method is generating several analytical inputs using the following approaches: 1) edge measure; and 2) skill score measure. Edge and skill are measured at the total excess return level, factor excess return level, and stock selection excess return level. Two rolling window periods (e.g., 24 months and 36 months) are used in an exemplary embodiment. Each manager's three-year forward rolling excess return are measured and then quartiled.

Using the edge metrics, skill metrics, and assessment of manager quartiles, a logistic regression model and a cross sectional recursive regression model are calibrated using a variety of combination of inputs to forecast the probability of membership in a particular performance quartile, thereby allowing for identification of Portfolio Managers/Products that are most likely to outperform their peers.

It is therefore an objective of the present invention to provide a system that can make determinations of Portfolio Manager skill across various dimensions apart from the impact of temporal market factors and other factors that passively favor or disfavor a Portfolio Manager's particular investment approach.

It is another objective of the present invention to use an assessment of a Portfolio Manager's skill (as compared to the influence of luck) to determine whether a Portfolio Manager/Product is suitable for inclusion in a particular portfolio.

In the light of the foregoing, these and other objectives are accomplished through the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 depicts an exemplary embodiment of a data processing device through which the present method can be implemented.

FIGS. 2A and 2B show exemplary flowcharts of the present method.

### DETAILED DESCRIPTION OF THE INVENTION

The present invention is directed towards a system and method for selecting Portfolio Managers/Products. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form. Furthermore, terms “customer” and “user” are used interchangeably, unless the context clearly indicates otherwise. It is to be appreciated that determinations or inferences referenced throughout the subject specification can be practiced through the use of artificial intelligence techniques.

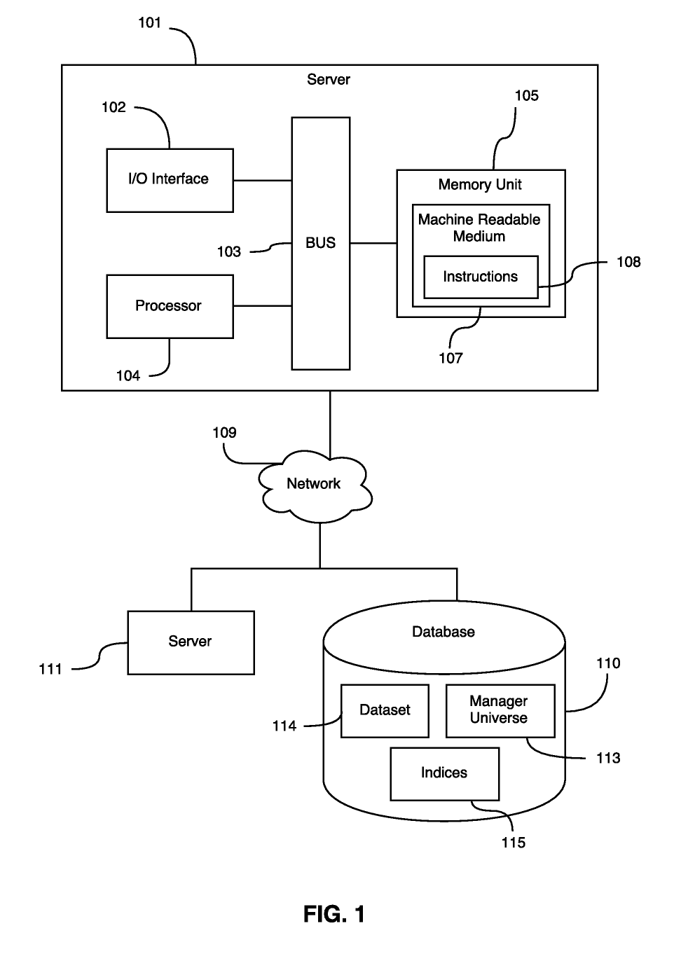

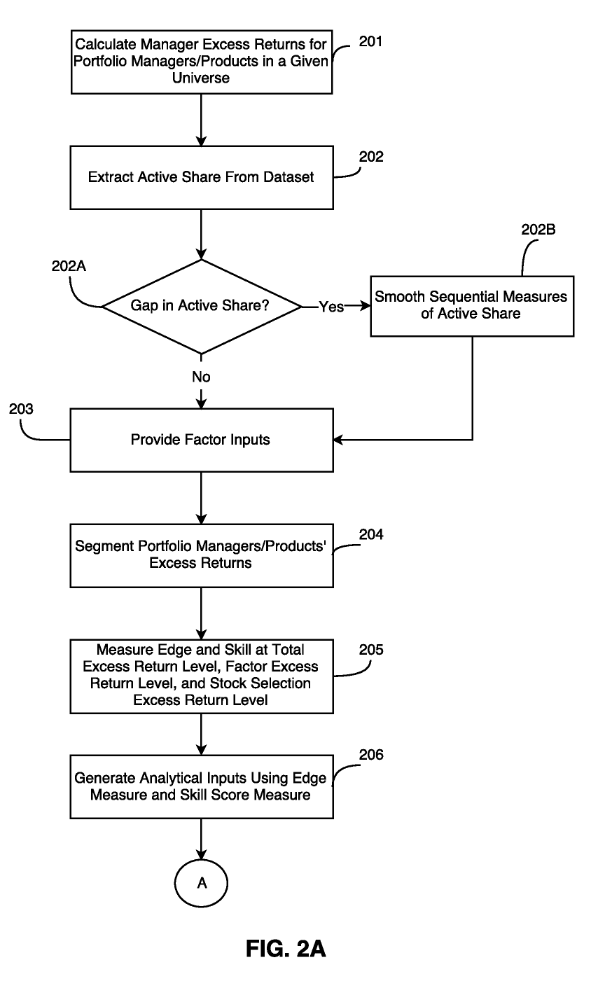

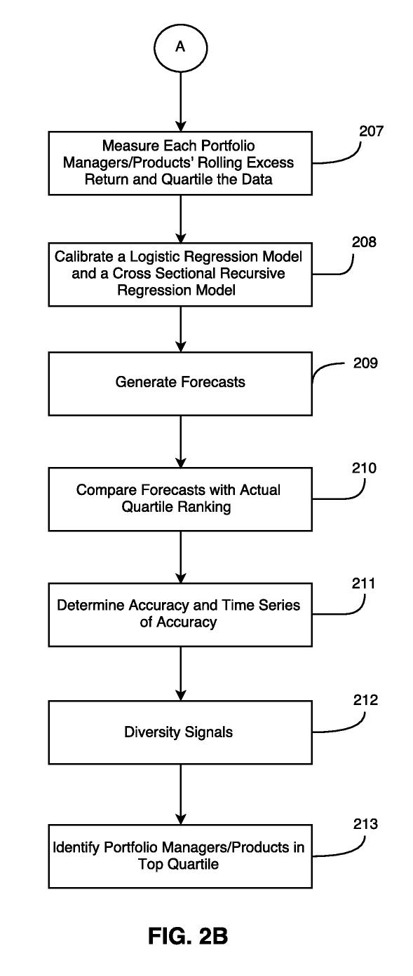

Referring now to FIG. 1, there is shown exemplary block diagrams of the present system. The present system comprises at least one server device 101. The server device 101 comprises various types of computer systems and similar data processing device, such as a desktop computer, laptop, handheld computing device, a mobile device, tablet computer, a personal digital assistant (PDA), and the like. The device 101 can operate as a standalone device or may be connected to third party devices 111 via a network 109 (e.g., the Internet, LAN). Without limitation, the third party devices 111 comprise servers, including on-site servers and cloud based servers. In a networked embodiment, the device 101 can operate in the capacity of a server (as illustrated in FIG. 2) or a client machine in a server-client network environment, or as a peer machine in a peer-to-peer (or distributed) network environment.

The device 101 includes a processor 104 (e.g., a central processing unit), input/output (I/O) interface 102, and a non-transitory computer readable storage medium 107 in a memory unit 105 containing instructions 108, wherein these components communicate with each other via a BUS 103. Without limitation, I/O interface 102 comprises alphanumeric input devices (e.g., a keyboard), a navigation device (e.g., a mouse), speakers, cameras, microphones, and the like. It is noted that the device 101 may comprise additional components that are necessary for operating the device 101, depending upon embodiment. For example, the device 101 may further include a display unit, a disk drive unit, a signal generation device, a network interface device, an environmental input device, and sensors.

The processor 104 communicates with the memory unit 105 so as to access the instructions 108 stored thereon. The memory unit 105 comprises any non-transitory computer readable medium 107 on which is stored one or more sets of data structures and instructions 108 embodying or utilized by any one or more of the methodologies or functions described herein. Without limitation, the memory unit 105 may comprise a random access memory (RAM), read-only memory (ROM), a floppy disk, a compact disc, digital video device, a magnetic disk, an ASIC, a configured processor, or other storage device. Additionally, the device 101 may communicate with one or more remote databases 110 connected thereto. It is also noted that the instructions 108 may also reside, completely or at least partially, within a disk drive unit and/or within the processor 104, depending upon embodiment. In this regard, the disk drive unit and/or the processor 104 may also constitute machine-readable media.

The instructions 108 comprise executable code written in any suitable computer-programming language. In this regard, the instructions 108 may comprise a software application, a web application, a mobile application, and the like. It is contemplated that the software application, the web application, and/or the mobile application comprises a graphical user interface (GUI) component for receiving user input and outputting or displaying information. The instructions 108, when executed on the processor 104, cause the processor 104 to perform operations. The operations include generating and analyzing data to identify turning points in segment, factor, and manager performance.

The first step of the operations primarily involves preparing data. Data is prepared using subsets of listed funds from the Petajisto (2013) dataset that are benchmarked against the Russell 1000 Index as well as registered mutual funds classified by Morningstar, Inc. (Morningstar) benchmarked against the Russell 2000, S&P 600 and MSCI EAFE indices. The methodology also evaluates the performance of stocks of different factor and industry groups for various categories of investment management styles within the broad public equity stock universe. The present invention also extracts Active Share data for the mutual funds incorporated in the Petajisto and Morningstar datasets, computed separately each quarter when fund holdings are disclosed. The benchmark index is the official benchmark index disclosed in the prospectus. The file also reports the benchmark index that produces the lowest Active Share. It is noted that the datasets are stored and/or derived from the database 110 and/or the servers 111.

It is noted, however, that the present invention is not intended to be limited to Portfolio Managers/Products that are benchmarked against the Russell 1000, Russell 2000, S&P 600 and MSCI EAFE indices only and/or the Petajisto or Morningstar datasets; any type of suitable indices and datasets may be utilized. Any group of public equity securities, including one developed by the user of the present method, could also be substituted for the aforementioned indices and datasets. Moreover, any data or information related to each index 115 or dataset 114, as well as data pertaining to a universe of managers 113, e.g., Portfolio Managers/Products, may be stored in one or more databases 110.

The processor 104 calculates manager excess returns using a subset of the Petajisto universe as the base universe for Large Capitalization U.S. equity managers and Morningstar mutual fund database for Small Capitalization U.S. equity managers and Non-U.S. equity managers. Manager excess returns are calculated against the Russell 1000 Index for Large Capitalization U.S. equity managers, the Russell 2000 Index for Small Capitalization U.S. equity managers, and the MSCI EAFE Index for Non-U.S. equity managers. Additionally, the processor 104 extracts Active Share from the Petajisto and Morningstar datasets, which is stored in the database 110. Similarly, the processor 104 extracts raw factor data for factors and industries from Barra using the FactSet Portfolio tools (SPAR/Portfolio Analytics); and generates composite indices for sectors using Barra industry risk data, mapped to GICS Sectors, then combines into a single index using a volatility-weighted approach. The processor 104 then segments the managers' excess returns into overall excess return, factor “clone” excess return, and stock selection excess return.

The second step of the operations involves generating several analytical inputs using the following approaches: 1) edge measure; and 2) skill score measure. Edge and skill are measured at the total excess return level, factor excess return level, and stock selection level. Two rolling window periods (e.g., 24 months and 36 months) are used to generate and/or obtain sufficient amounts of data. Each manager's three-year forward rolling excess return are measured and then quartiled.

The operation further includes calibrating a logistic regression model and a cross sectional recursive regression model, wherein the step of calibrating a logistic regression model comprises the steps of generating forecasts via cross sectional recursive regressions. These models use the edge metrics, skill metrics, Active Share data, assessment of Portfolio Manager/Product quartiles, and a variety of combination of inputs to forecast the probability of membership in quartiles above that of the median of the peer universe of Portfolio Managers/Products. This allows for identification of Portfolio Managers/Products that are most likely to outperform the universe of their peers.

Referring now to FIGS. 2A and 2B, there is shown an exemplary flowchart of the present method. In the step indicated by the diagram block 201, Portfolio Manager/Product excess returns are calculated for a peer universe using a subset of the Petajisto U.S. equity universe as the base universe for Large Capitalization U.S. equity managers benchmarked to the Russell 1000 Index, the Morningstar mutual fund universe for the Small Capitalization U.S. equity managers and Non-U.S. equity managers. Additionally, Portfolio Manager/Product excess returns are calculated against the Russell 1000 Index for Large Capitalization U.S. equity managers, the Russell 2000 Index for Small Capitalization U.S. equity managers and the MSCI EAFE Index for Non-U.S. equity managers.

For Non-U.S. equity Portfolio Managers/Products, an Oil Factor that was developed using the geometric mean of the spot price (first month future) for ICE Brent Crude Futures and the futures for one year forward in three month increments (fourth month, seventh month, tenth month, and thirteenth month) are also included. This approach dampens some of the volatility associated with the spot price while still capturing the variability and incorporates information from the future curve. In other words, this approach reduces the weight of outliers while retaining the degree of variation exhibited in movements of the front end of the oil futures curve. To create the return series, the monthly percentage change in this mean price of oil is measured.

In the step indicated by the diagram block 202, Active Share is taken directly from either the Petajisto or Morningstar dataset. Where there are gaps in information in the Petajisto dataset 202A, sequential measures of Active Share are smoothed to complete the dataset 202B.

In the step indicated by the diagram block 203, factor inputs are provided. The factor inputs, i.e., variables, comprise raw factor data for factors and industries extracted from Barra using the FactSet Portfolio tools (SPAR/Portfolio Analytics). Factors from the USE4 Model are used for U.S. equity and the GEM3 Model for global equity. Composite indices for sectors (cyclical, defensive, interest rate sensitive) are generated using Barra industry risk data, mapped to GICS sectors, then combined into a single index using a volatility-weighted approach, described in accordance with the following mapping shown in Tables 1 and 2:

TABLE 1
Internally Developed FactSet Factors vs. Barra Factors

| FACTSET FACTORS | BARRA FACTORS | BARRA FACTORS METHODOLOGY |
|---|---|---|
| Big vs. Small | Size Factor | Log of the market capitalization of the firm |
| Long Term Debt to | Leverage Factor | 0.75 * Market Leverage + 0.15 * Debt to |
| Equity | | Asset + 0.1 * Book Leverage |
| Price Momentum | Momentum Factor | The sum of excess log returns over the |
| | | trailing 504 trading days with a lag of 21 |
| | | trading days in order to avoid the effects of |
| | | short-term reversal |
| Price to Book | 1/Book to Price Factor | Last reported book value of common |
| | | equity divided by current market |
| | | capitalization |
| Price to Earnings | 1/Earning Yield Factor | 0.75 * Predicted Earnings to Price Ratio + |
| Price to Cash Flow Ratio | | 0.15 * Cash Earning to Price Ratio + |
| Price to Earnings NTM | | 0.1 * Trailing Earnings to Price Ratio |
| Sales Growth 1 Year | Growth Factor | 0.7 * Long Term Predicted Earnings Growth + |
| Earnings Momentum | | 0.2 * Trailing Five Years Earnings Growth + |
| EPS_LTG | | 0.1 * Trailing Five Years Sales Growth |

TABLE 2
Sector Groups

Interest Rate Sensitive (Financials and Consumer Discretionary)
Defensive (Health Care, Consumer Staples, Telecommunications and
Utilities)
Cyclical (Industrials, Materials, Information Technology, Energy (minus
the Oil and Gas sub-industry)
Oil and Gas Sub-Industry

In developing the inputs for the Sector Factors, a volatility weighting approach is used. The intent of this approach is to adjust the weights of sectors dynamically, using a 24-month rolling window, so that no single sector dominates any particular factor. In developing the weights, the variance of returns for a given factor is measured and inversed to yield an inverse variance. This procedure is completed for each of the ten GICS sectors. The measure of inverse variance is then divided by the total variance across sectors associated with a particular factor (e.g., Consumer Discretionary and Financials for Rate Sensitive). The weights are then multiplied and calculated using a look back window of 24 months by the current month returns for the factor. The sum represents the current month input for each factor.

In order to address the potential for multicollinearity, the Oil and Gas sub-industry factor returns are removed from the Energy sector factor derived from volatility-weighted sub-industry factor returns. Remaining sub-industries are related to services and equipment, both of which have less direct correlation with the oil price.

In the step indicated by the diagram block 204, the Portfolio Manager's/Product's excess returns are segmented into overall excess return, factor “clone” excess return, and stock selection excess return, which are expressed in the following equation:

$${ExcessReturn}_{i} = {R}_{i} - M$$

$${R}_{i} = α + {\sum }_{i} ( {β}_{i , j} \times {F}_{j} )$$

$$M = {α}_{mkt} + {\sum }_{j} ( {β}_{mkt , j} \times {F}_{j} ) \\ ∴ {ExcessReturn}_{i} = ( {α}_{i} - {α}_{mkt} ) + {\sum }_{j} [ ( {β}_{i , j} - {β}_{mkt} ) \times {F}_{j} ]$$

wherein:
i=Portfolio Manager/Product number;
j=factor number;
R=Portfolio Manager/Product return;
M=market return;
F=factor return;
α=intercept; and
β=sensitivity with respect to each factor F.

Portfolio Manager/Product excess returns are decomposed into factor clone return Σⱼ[β_{i,j}−βₘₖₜ)×Fⱼ] and stock selection return (αᵢ−αₘₖₜ) in order to help better understand a Portfolio Manager's/Product's investment style and decide which effect is attributable to Portfolio Manager's/Product's performance.

Several analytical inputs are generated in step 206, using two basic approaches: 1) edge measure; and 2) skill score measure. Edge and skill are measured 205 at the total excess return level, the factor excess return level, and stock selection excess return level. In this regard, two rolling window periods, 24 months and 36 months, are used, though other time periods may be used, depending upon embodiment. Edge measure uses the Kelly Criterion, which measures an “edge,” or an advantage in a bet. In this regard, if the edge is zero, then the criterion recommends the gambler bets nothing. If the edge is negative, then the criterion recommends the gambler to take the other side of the bet. The formula effectively suggests scaling an edge by the odds of winning to determine the wealth-maximizing wager in an uncertain outcome. The odds and edge are not measured as the empirical probability-weighted value of excess return. As a practical matter, this is the mathematical equivalent of the rolling average of excess return.

Skill score measure is measured by assessing the ability of Portfolio Managers/Products to outperform the index on a “pass-fail” basis over a period of time. Positive excess return yields a value of 1, while negative excess return yields a value of 0. Thus, this is a binary series of data. Taking this fact into account, the probability of outperformance given the total number of trials is measured, assuming randomness (i.e., 50% probability of positive excess return). The cumulative probability is then converted to a z-score using an inverse normal distribution. As the total number of trials approaches infinity, the binomial distribution approaches the normal distribution. As a practical matter, the assumption of similarity can benchmark and develop the skill metric.

In developing the skill scoring methodology, therefore, the present system and method attempt to equate Portfolio Manager/Product performance with flipping coins. In this way, the system enables users to assess the likelihood that a Portfolio Manager's/Product's return stream was randomly generated using a z-score. The approach is described further in the example below:

### Example 1

1) A Portfolio Manager's/Product's returns versus a relevant benchmark are measured. The series of positive and negative returns are converted to a binary stream, using “1” to identify positive excess returns and “0” to identify negative excess returns.
2) Using this binary stream, the probability of occurrence is determined using the binomial distribution. As noted above, each “1” represents a successful trial; each “0” represents an unsuccessful trial. Therefore, the probability of success is assumed to be 50%, effectively suggesting that Portfolio Manager/Product outperformance is a random occurrence. Using this approach, the cumulative density of the binomial distribution is calculated. The binomial distribution is suited for the present method because it measures a set of discrete outcomes in a given sample set.
3) As the number of observations approaches infinity, the binomial distribution and normal distribution are approximately equal. While it is noted that the dataset is not likely to actually approach infinity in operation, this is used to generate a score to rank Portfolio Managers/Products given the likelihood of their ability to outperform a benchmark. The cumulative probability for the binomial distribution is then used to calculate the inverse of the standard normal distribution curve.
4) The resultant measure given the above approach is a z-score. The z-score is used as a measure of skill. The further the z-score is from the value of 0, the more likely it is that a Portfolio Manager's/Product's performance stream was generated with skill versus luck. In this regard, a high z-score is desired; and a Portfolio Manager/Product may be selected for inclusion in a portfolio if the z-score is above a predetermined threshold.

For the purposes of segmentation, each Portfolio Manager's/Product's three-year forward rolling excess return is measured and then quartiled to determine to which group it should be assigned for the subsequent 36 months given the present metrics 207. In other embodiments, however, it is contemplated that other periods of time may be used. In this regard, information related to each Portfolio Manager/Product from a short historic window is incorporated.

Using the edge and skill metrics, along with the assessment of Portfolio Manager/Product quartiles over time, a logistic regression model and a cross sectional recursive regression model are calibrated 208. It is noted that other combinations of inputs may also be used to forecast the probability of membership in quartiles above that of the median of the peer universe of Portfolio Managers/Products over the subsequent 36-month period.

The methodology also uses Active Share, which is a measure of the percentage of stock holdings in a Portfolio Manager's/Product's portfolio that differ from the benchmark index. The present methodology extracts this data from both the Petajisto and Morningstar datasets referenced above. Where there are gaps in information in the Petajisto dataset, sequential measures of Active Share are smoothed to complete the dataset.

Logistic regression and cross sectional recursive regression are used to forecast Portfolio Manager/Product future performance. Logistic regression measures the relationship between a categorical dependent variable and one or more independent variables, which are usually (but not necessarily) continuous, by using probability scores as the predicted values of the dependent variable. The following example describes a forecasting model. In this case, the dependent variable being forecasted is the probability of a Portfolio Manager's/Product's membership in a particular performance quartile comprised of their strategy or style peers over the subsequent three-year period.

### Example 2

A dataset for a forecasting model may comprise Portfolio Manager/Product historical monthly data for a given period of time, wherein the forecasting model is a combination model comprising a plurality of individual models. In one embodiment, the combination model includes Edge (Total, Factor and Stock Selection), Raw Active Share, Active Share Tercile, and Skill Score (Total, Factor and Stock Selection) models. In one embodiment, the dataset may comprise data for 299 managers from November 2001 to February 2011. In another embodiment, the dataset may comprise data for 286 managers from January 2002 to December 2011. The dataset may further comprise independent variables and a dependent variable. Independent variables comprise rolling 24-months and 36-month Edge (Total, Excess, Factor, Stock Selection), Skill Score (Total, Excess, Factor, Stock Selection) and Active Share. The dependent variable comprises forward 36-month return quartile ranking.

In one embodiment, logistic regression and cross sectional recursive regressions are used to test multiple independent factors, and select the best predictor(s) for the dependent variable. This method is used to generate forecasts 209, with the first regression including initial 24 observations. To avoid look-ahead bias in the dependent variable, the methodology multiplies regression betas with out-of-sample independent variables to forecast 3-year forward returns. Accuracies are measured by comparing forecasts with Portfolio Manager/Product true quartile ranking each of the corresponding month or sample time period 210. In this regard, Q1, i.e., Quartile 1, accuracy is correct if both forecast and actual show the same above median Portfolio Manager/Product in Quartile 1. It is contemplated that Portfolio Managers/Products that are in the top quartile are expected to outperform 213. Median accuracy is correct if both forecast and actual show the same Portfolio Manager/Product above median or below median.

To determine the efficacy of each of the forecast models, an analysis is performed to determine the overall accuracy and time series of accuracy for each one 211. In addition, combinations of forecasts are assessed to determine whether diversifying a signal 212 makes a material difference in accuracy of forecasting the Portfolio Managers/Products that are expected to be in the top quartile. The forecast models, in isolation, are intended to identify the Portfolio Managers/Products that are most likely to outperform.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A computer-implemented method for selecting a Portfolio Manager/Product for an investment portfolio, the method comprising the steps of:
calculating, by a computer system in a network, overall excess returns in excess of an index return for each Portfolio Manager/Product in a universe, wherein said universe is maintained in a database within said network;
extracting, from a dataset in said network to said computer system, Active Share data for financial products;
receiving, at said computer system, factor inputs, wherein said factor inputs comprise extracted raw factor data for factors and industries and a single index;
segmenting, by said computer system, said overall excess returns of each of said Portfolio Manager/Product by calculating factor clone excess return and stock selection excess return, wherein said factor clone excess return identifies the impact of temporal market events;
measuring, by said computer system, edge measures and skill scores at said overall excess return, said factor clone excess return, and said stock selection excess return;
determining, by said computer systems, Portfolio Manager/Product quartiles over a period of time using a forward rolling excess return for said period of time;
calibrating, by said computer system, a logistic regression model and a cross sectional recursive regression model using said edge measures, said skill scores, said Active Share, and said Portfolio Manager/Product quartiles to generate a forecast model, wherein said skill scores comprise a cumulative probability of outperforming the index that is converted to a z-score using an inverse normal distribution, further wherein said z-score is directly proportional to a Portfolio Manager's skill; and
identifying, by said computer system, each of said Portfolio Manager/Product that is in a top quartile of said forecast model.

2. The method of claim 1, wherein said overall excess returns are calculated against one or more stock market index.

3. The method of claim 1, further comprising the steps of: identifying one or more gaps in measures of said Active Share and smoothing sequential measures of said Active Share, by said computer system.

4. The method of claim 1, wherein said logistic regression model comprises a dataset comprising independent variables and a dependent variable;
said independent variables comprising said edge measures, said skill scores derived from each Portfolio Manager's/Product's historical monthly data for a given period of time and Active Share; and
said dependent variable comprising forward return quartile ranking for said given period of time.

5. The method of claim 1, wherein the steps of calibrating said logistic regression model further comprises the steps of: generating, by said computer system said forecast model via cross sectional recursive regressions.

6. The method of claim 1, further comprising the steps of: comparing the performance forecasted by said forecast model with true quartile ranking of each of said Portfolio Manager/Product for a corresponding time period.

7. A non-transitory computer-readable storage medium with an executable program stored thereon, wherein the program instructs a processor to perform the following steps:
calculate, by a computer system in a network, overall excess returns in excess of an index return for each Portfolio Manager/Product in a universe, wherein said universe is maintained in a database within said network;
extract, from a dataset in said network to said computer system, Active Share data for financial products;
receive, at said computer system, factor inputs, wherein said factor inputs comprise extracted raw factor data for factors and industries and a single index;
segment, by said computer system, said overall excess returns of each of said Portfolio Manager/Product by calculating factor clone excess return and stock selection excess return, wherein said factor clone excess return identifies the impact of temporal market events;
measure, by said computer system, edge and skill scores at said overall excess return, said factor clone excess return, and said stock selection excess return;
determine, by said computer system, Portfolio Manager/Product quartiles over a period of time using a forward rolling excess return for said period of time;
calibrate, by said computer system, a logistic regression model and a cross sectional recursive regression model using said edge measures, said skill scores, said Active Share, and said Portfolio Manager/Product quartiles to generate a forecast model, wherein said skill scores comprise a cumulative probability of outperforming the index that is converted to a z-score using an inverse normal distribution, further wherein said z-score is directly proportional to a Portfolio Manager's skill; and
identify, by said computer system, each of said Portfolio Manager/Product that is in top quartile of said forecast model.

8. The non-transitory computer-readable storage medium of claim 7, wherein said overall excess returns are calculated against a stock market index.

9. The non-transitory computer-readable storage medium of claim 7, wherein said program further instructs said processor to perform the following steps: identify one or more gaps in measures of said Active Share and smooth sequential measures of said Active Share, by said computer system.

10. The non-transitory computer-readable storage medium of claim 7, wherein said logistic regression model comprises a dataset comprising independent variables and dependent variable;
said independent variables comprising said Active Share, edge measures, and said skill scores derived from each Portfolio Manager's/Product's historical monthly data for a given period of time; and
said dependent variable comprising forward return quartile ranking for a period of time.

11. The non-transitory computer-readable storage medium of claim 7, wherein said program further instructs said processor to generate, by said computer system, said forecast model via cross sectional recursive regressions.

12. The non-transitory computer-readable storage medium of claim 7, wherein said program further instructs said processor to perform the following steps: compare the performance forecasted by said forecast model with true quartile ranking of each of said Portfolio Manager/Product for a corresponding time period.
